(19) United States
(12) Patent Application Publication
(10) Pub. No.: US 2025/0317964 A1
(43) Pub. Date: Oct. 9, 2025

(54) WIRELESS COMMUNICATIONS CHANNEL SWITCHING DEVICES AND METHODS

(71) Applicant: NXP USA, Inc., AUSTIN, TX (US)

(72) Inventor: Liwen Chu, San Ramon, CA (US)

(21) Appl. No.: 19/169,854

(22) Filed: Apr. 3, 2025

Related U.S. Application Data
(60) Provisional application No. 63/574,157, filed on Apr. 3, 2024.

(51) Int. Cl. H04W 74/08; H04W 74/00; H04W 84/12

(52) U.S. Cl. CPC H04W 74/08; H04W 74/002; H04W 84/12

(57) ABSTRACT

One example discloses a wireless communications device, including: a controller configured to switch the wireless communications device from a first operating channel to a second operating channel according to a set of operating parameters; wherein the set of operating parameters include at least one of: a padding delay or a switching delay which defines a delay for switching to the second operating channel from the first operating channel; a transition delay or a switch back delay which defines a delay for switching back to the first operating channel from the second operating channel.

### REFERENCE TO PROVISIONAL APPLICATION TO CLAIM PRIORITY

A priority date for this present U.S. patent application has been established by prior U.S. Provisional Patent Application, Ser. No. 63/574,157, entitled “Channel Switch Operation Of Dso And Npc”, filed on 3 Apr. 2024, and commonly assigned to NXP USA, Inc.

The present specification relates to systems, methods, apparatuses, devices, articles of manufacture and instructions for wireless communications channel switching.

### SUMMARY

According to an example embodiment, a wireless communications device, comprising: a controller is configured to switch the wireless communications device from a first operating channel to a second operating channel according to either a Non-Primary Channel Access (NPCA) channel switching protocol or a Dynamic Subchannel Operation (DSO) channel switching protocol; wherein the wireless communications device is an access point (AP) that is configured to operate in a wireless local area network (WLAN) with at least one station (STA); wherein the AP is configured to announce an enabling and/or disabling of the NPCA and/or the DSO protocols; wherein the AP is configured to accept a negotiation request from the STA; wherein the STA is configured to respectively negotiate a set of NPCA and/or DSO operating parameters in response to the AP enabling the NPCA and/or DSO protocols; wherein the controller is configured to switch the wireless communications device from the first operating channel to the second operating channel according to the set of NPCA and/or DSO operating parameters; and wherein the set of NPCA and/or DSO operating parameters include at least one of: a padding delay or a switching delay which defines a delay for switching to the second operating channel from the first operating channel; and a transition delay or a switch back delay which defines a delay for switching back to the first operating channel from the second operating channel.

According to an example embodiment, a wireless communications device, comprising: a controller configured to switch the wireless communications device from a first operating channel to a second operating channel according to a set of operating parameters; wherein the set of operating parameters include at least one of: a padding delay or a switching delay which defines a delay for switching to the second operating channel from the first operating channel; a transition delay or a switch back delay which defines a delay for switching back to the first operating channel from the second operating channel.

In another example embodiment, at least one of the padding, transition, switch, or switch back delays has between a 4 μs granularity and a 32 μs granularity.

In another example embodiment, at least one of the padding, transition, switch, or switch back delays has a granularity of at least one of: 1 μs, 4 μs, 16 μs, and 32 μs.

In another example embodiment, the controller is configured to switch the wireless communications device from the first operating channel to the second operating channel according to a Non-Primary Channel Access (NPCA) channel switching protocol.

In another example embodiment, the controller is configured to switch the wireless communications device from the first operating channel to the second operating channel according to a Dynamic Subchannel Operation (DSO) channel switching protocol.

In another example embodiment, the wireless communications device is either an access point (AP) or a station (STA) that is configured to operate in a wireless local area network (WLAN).

In another example embodiment, the controller is configured to switch the wireless communications device from the first operating channel to the second operating channel after obtaining a TXOP.

In another example embodiment, the controller is configured to switch the wireless communications device from the second operating channel back to the first operating channel before releasing the TXOP.

In another example embodiment, the controller is configured to negotiate at least one of the padding, transition, switch, or switch back delays within either an AP's beacon or probe response frame, and/or a STA's enable/disable request frame.

In another example embodiment, at least one of the padding, transition, switch, or switch back delays is included in an HE control field within either an AP's beacon or probe response frame, and/or a STA's enable/disable request frame.

In another example embodiment, the first operating channel is an anchor channel; and the second operating channel is included in a set of non-anchor channels.

In another example embodiment, the wireless communications device is an access point (AP); the AP is configured to wirelessly communicate with a station (STA) as a wireless local area network (WLAN); and the controller is configured to set the anchor channel to have an operating BW equal to an operating BW of the STA.

In another example embodiment, the wireless communications device is an access point (AP); the AP is configured to wirelessly communicate with a station (STA) as a wireless local area network (WLAN); the controller is configured to set the anchor channel to have a fixed BW; and the STA has an operating BW that covers the fixed BW.

In another example embodiment, the wireless communications device is an access point (AP); the AP is configured to wirelessly communicate with a station (STA) as a wireless local area network (WLAN); and the AP is either prohibited from scheduling, or permitted to schedule, a STA for dynamic channel switching once the STA switches back to the anchor channel.

In another example embodiment, if at least one of the padding, transition, switch, or switch back delays is more than a predetermined threshold delay, then the controller is prevented from switching the wireless communications device from the first operating channel to the second operating channel.

In another example embodiment, the controller is permitted to switch the wireless communications device from the first operating channel to the second operating channel only if at least one of the padding, transition, switch, or switch back delays is less than a predetermined threshold delay.

According to an example embodiment, z method for wireless communications channel switching, comprising: switching the wireless communications device from a first operating channel to a second operating channel according to a set of operating parameters; wherein the set of operating parameters include at least one of: a padding delay or a switching delay which defines a delay for switching to the second operating channel from the first operating channel; and a transition delay or a switch back delay which defines a delay for switching back to the first operating channel from the second operating channel.

The above discussion is not intended to represent every example embodiment or every implementation within the scope of the current or future Claim sets. The Figures and Detailed Description that follow also exemplify various example embodiments.

Various example embodiments may be more completely understood in consideration of the following Detailed Description in connection with the accompanying Drawings.

### BRIEF DESCRIPTION OF THE DRAWINGS

FIG. 1 represents a example wireless communications system for hosting Non-Primary Channel Access (NPCA) and Dynamic Subchannel Operation (DSO) channel switching protocols.

FIG. 2 represents an example set of Non-Primary Channel Access (NPCA) channels.

FIG. 3A represents an example protocol for DSO enabling/disabling within the wireless communications system.

FIG. 3B represents an example protocol for NPCA enabling/disabling within the wireless communications system.

FIG. 4A represents an example padding delay.

FIG. 4B represents an example transition delay.

FIG. 5 represents an example set of instructions for setting a channel padding, transition, switch, or switch back delay in the wireless communications system.

FIG. 6 represents an example set of instructions for updating a channel padding, transition, switch, or switch back delay in response to a change in the STA's operating BW.

FIG. 7 represents an example set of instructions for negotiating a channel padding, transition, switch, or switch back delay in the wireless communications system.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

### DETAILED DESCRIPTION

Wireless communications networks (e.g. IEEE 802.11 protocols) are useful in a variety of applications, including industrial, medical, computer network, edge IoT, and home applications. As data requirements of such applications increase there is an increasing need for the wireless communications systems that support them increase their bandwidth as well.

For example, IEEE § 802.11 protocols can include single-link or multi-link communications between various access points (APs) and-stations (STAs). Each of these APs and STAs in turn can operate on a variety of channels (e.g. frequencies). Such channels may have variety of labels (e.g. primary channel, non-primary, secondary channel, anchor channel, non-anchor channel, etc.). For enabling increased data bandwidth (e.g. throughput) such APs and STAs, channel switching has proven beneficial.

Channel switching allows APs and STAs to using a different channel when a current channel is too busy/congested or when the STAs have narrow bandwidth than the BSS operating bandwidth. Such channel switching enhances network performance and efficiency, optimizes bandwidth utilization, and reduces delays caused by collisions.

Different protocols for channel switching include: Non-Primary Channel Access (NPCA) and Dynamic Subchannel Operation (DSO).

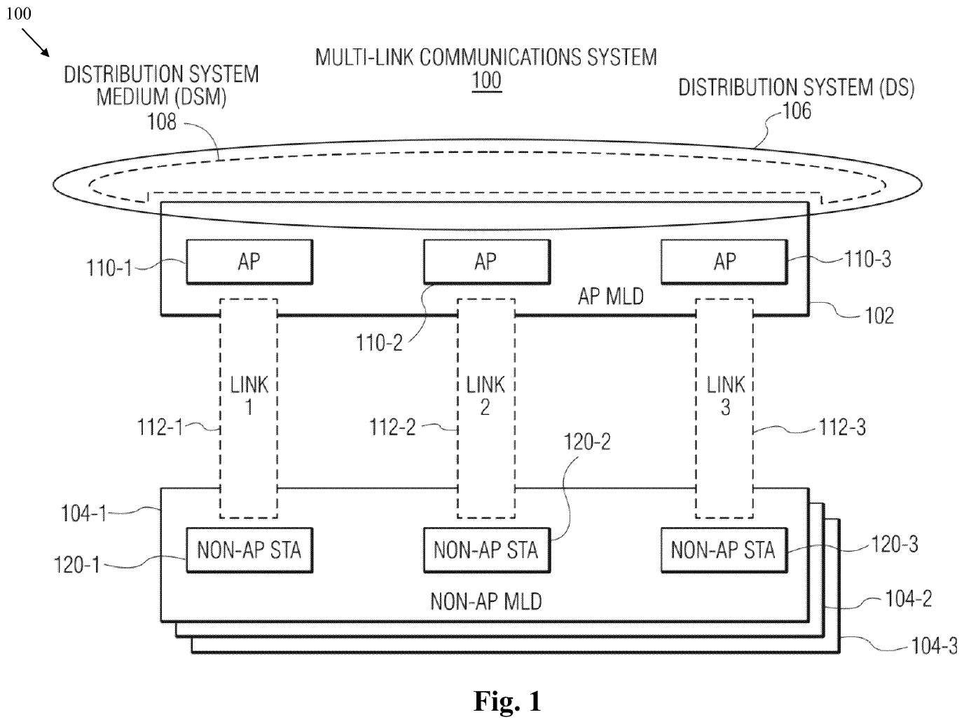

FIG. 1 represents a general example wireless communications system 100 for hosting NPCA and DSO channel switching protocols. In various example embodiments, the wireless communications system 100 is configured as a WLAN (wireless local area network)

The wireless communications system 100 includes: at least one logical AP-MLD (Access Point Multi-Link Device) 102; a set of logical non-AP-MLDs 104-1, 104-2, 104-3; a distribution system (DS) 106; and a set of communications links 112-1, 112-2, 112-3. “Logical” is herein defined to include, for example, a set of physical devices abstractly aggregated into a single logical device for the purposes of communication and/or other functions.

For example, the logical AP-MLD 102 can include a set of physical APs (access points) 110-1, 110-2, 110-3. Similarly, the logical non-AP-MLDs 104-1 can include a set of physical non-AP-STA (stations) 120-1, 120-2, 120-3. The other non-AP-MLD 104-2, 104-3 may also include additional physical non-AP-STAs.

The AP-MLD 102 is coupled to a distribution system (DS) 106 through a distribution system medium (DSM) 108. The distribution system (DS) 106 is used to interconnect basic service sets (BSSs) and local area networks (LANs) to create an extended service set (ESS).

In IEEE 802.11 a service set (aka. extended service set (ESS)) is a group of wireless devices which are identified by a same SSID (service set identifier). A service set forms a logical network. A basic service set (BSS) is a subgroup of wireless devices within a service set operating with similar physical layer medium access characteristics (i.e. radio frequency, modulation scheme, security settings etc.) and that are wirelessly networked. Devices within basic service sets are identified by BSSIDs (basic service set identifiers).

The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves).

The APs 110-1, 110-2, 110-3 may be implemented in hardware (e.g. circuits, IC, etc.), software, firmware, or a combination thereof. The APs 110-1, 110-2, 110-3 may include one or more antennas, transceivers, and controllers operably interconnected. The transceivers may include a physical layer (PHY) device.

The controllers may be configured to process various data packets (e.g. PDUs, SDUs, etc.) received and/or to be transmitted. The APs 110-1, 110-2, 110-3 can be configured as either wired or wireless APs coupled to a LAN (local area network), a WLAN (wireless local area network), and/or a backbone network (e.g., the Internet). The AP-MLD 102 may also include a Media Access Control (MAC) data service interface, with associated MAC address that enables this device to communicate with the DSM 108.

Similarly, the non-AP-STAs 120-1, 120-2, 120-3 in the non-AP-MLDs 104-1 may be implemented in hardware (e.g. circuits, IC, etc.), software, firmware, or a combination thereof. The non-AP-STAs 120-1, 120-2, 120-3 may include one or more antennas, transceivers, and controllers operably interconnected. These transceivers may include a physical layer (PHY) device.

The controllers may be configured to process various data packets (e.g. PDUs, SDUs, etc.) received and/or to be transmitted. Each of the non-AP-MLDs 104-2, 104-3 may also include non-AP-STAs (not shown).

The non-AP-MLDs 104-1, 104-2, 104-3 may also include a Media Access Control (MAC) data service interface, with associated MAC addresses that enable these devices to communicate with the DSM 108 over the communications links 112-1, 112-2, 112-3.

Example applications of the non-AP-STAs 120-1, 120-2, 120-3 include: laptop computers, tablet computers, desktop computers, mobile phones, edge devices, or other wireless devices.

In various example embodiments, one or more of the physical APs 110-1, 110-2, 110-3 and/or physical non-AP-STAs 120-1, 120-2, 120-3 may communicate over the links 112-1, 112-2, 112-3 in different frequency bands (e.g. 2.4 GHZ, 5 GHZ, 6 GHZ, etc.), for example, during multi-link device (MLD) operation setup and data packet (e.g. PDUs, SDUs, etc.) transfers.

In various example embodiments, each of the APs 110-1, 110-2, 110-3 may be an AP working in one link, and/or each of the non-AP-STAs 120-1, 120-2, 120-3 may be non-AP STA working in a link.

The physical communications links 112-1, 112-2, 112-3 may be logically defined as including one or more communications channels. In some example embodiments, different links however can be in a same frequency band. For example, two channels on a same 5 GHz band can form multi-links. Thus the links 112-1/2/3 in different channels of the same band are also allowed.

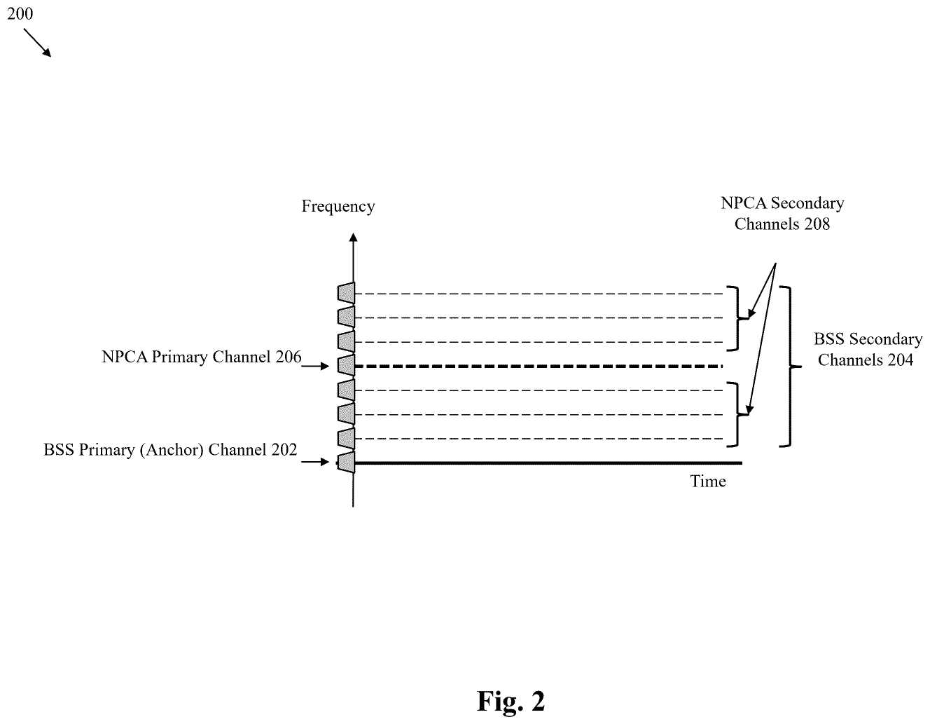

FIG. 2 represents an example set 200 of Non-Primary Channel Access (NPCA) channels. The example set 200 shows one possible set of frequency arrangements for multiple channels that APs and STAs can channel switch between. This particular example set 200 defines a Basic Service Set (BSS) primary (anchor) channel 202 and a set of BSS secondary channels 204. The BSS secondary channels 204 include an NPCA primary channel 206 and a set of NPCA secondary channels 208.

Dynamic Subchannel Operation (DSO) is another possible channel switching protocol/method that can coordinate AP and STA channel switching between channels and is discussed next.

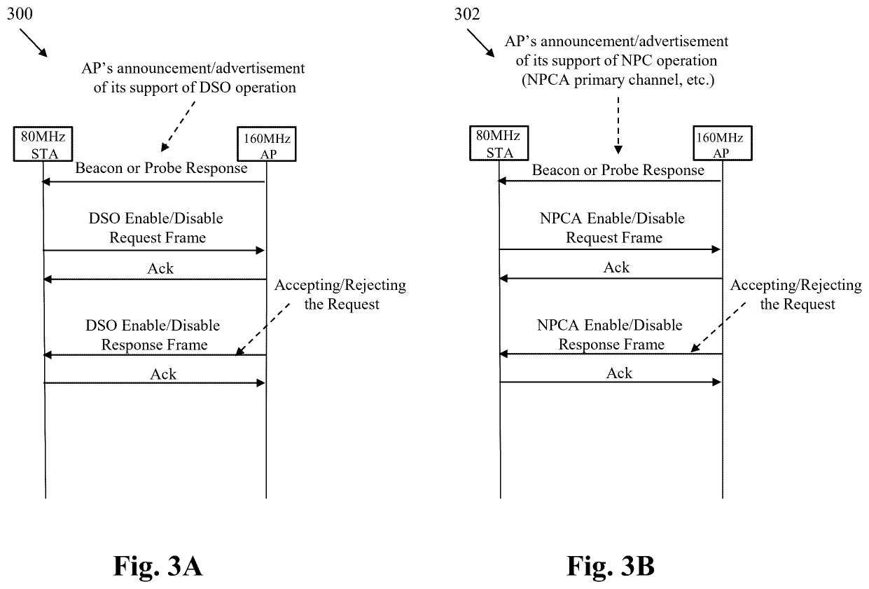

FIG. 3A represents an example protocol 300 for DSO enabling/disabling within the wireless communications system 100. The example protocol 300 for setting up a DSO channel switching can include: an AP's announcement/advertisement of its enabling/disabling for DSO operation by sending a Beacon or Probe Response to an associated non-AP STA with the related indication, the STA notifying its the AP that the STA is capable of operating according to a DSO protocol and requesting to enable/disable DSO if the AP announces the enabling of the DSO operation, the AP always accepting the request from the STA by sending a DSO response frame.

DSO frames can include: a DSO enable/disable request/response frame, and one or more DSO control frames.

Next, both the AP and the STA negotiate a set of DSO operation parameters. The DSO operation parameters can include: a mode indication, a set of defined channels (DSO channels), a padding delay, a transition delay, and etc. The set of DSO operation parameters of DSO channels and enabling of DSO operation are contained within the beacon or probe response frame from the AP, the set of DSO operation parameters of enabling DSO operation, padding delay and transition delay contained within the DSO enable request frame from the STA, and the set of DSO operation parameters of disabling DSO operation contained within the DSO disable request frame from the STA. The DSO enable/disable response frame confirm AP's accepting and readiness of the related enabling/disabling.

The padding delay defines a delay for switching to a DSO channels from the primary channel. While the transition delay defines a delay for switching back from the DSO channels to the primary channel.

An example of operating according to the DSO protocol can include: a non-AP STA and an associated AP exchanging frames on its current operating channel that covers the primary channel until a DSO control frame (ICF frame) that solicits the STA's switch from the STA's operating channel (the primary channel) to the DSO channels is sent by the associated AP at the beginning of the TXOP. Then upon receipt of the DSO control frame, the STA channel switch to the DSO channels for the frame exchanges with the AP in the TXOP as defined by the agreed upon DSO protocol. The STA switches back to the primary channel no later than the end of the TXOP.

In other words, upon obtaining a TXOP, the AP transmits a DSO control frame where the RU being allocated to the STA indicates the STA's switch to the DSO channels where the RU allocated to the STA defines (and is in line with) the STA's DSO channels. Upon receiving a DSO initial control frame in primary channel indicating a channel switch to the STA's DSO channels, the STA then switches to its DSO channels for the frame exchanges with the AP in the remaining time of the TXOP. The STA switch back to the primary channel no later than the end of the TXOP.

The DSO operation parameters can be updated/re-negotiated dynamically by either the AP and/or the STA (e.g. by sending a DSO enable/disable request/response frame) to maximize data throughput between the AP and STA.

When scheduling a STA's switch to DSO channels in a TXOP, the dynamic channel puncture is allowed in the TXOP.

Note, in some example embodiments it is not allowed that the AP schedules a STA to do dynamic channel switch after the STA switches to NPC's anchor channel, while in other example embodiments it is allowed that the AP schedules a STA to do dynamic channel switch after the STA switches to NPC's anchor channel.

In one example, for a 320 MHz BSS, the AP may announce three DSO subbands (i.e. three group of DSO channels). The three DSO subbands in some example applications may be a secondary 80 MHz channel, a first 80 MHz channel in secondary 160 MHz channel, and a second 80 MHz channel in secondary 160 MHz channel. In another example, for a 80 MHz BSS, the AP may announce three DSO subbands ((i.e. three group of DSO channel) for 20 MHz STAs. The three DSO subbands are secondary 20 MHz channel, the first 20 MHz channel of secondary 40 MHz channel, the second 20 MHz channel of secondary 40 MHz channel.

Example embodiments of an “anchor channel” are as follows. When referring to the anchor channel as the DSO subband of the STA for the DSO operation, the anchor channel has the BW of the STA's operating BW. In another example embodiment, the anchor channel is a 20 MHz secondary channel and the STA stays at its operating BW that covers the anchor channel. The STA then announces the requested DSO subband (anchor channel(s)) in a DSO Request, and the AP decides upon an agreed set of anchor channel(s).

In other words, when the STA requests one of three DSO subbands, the AP may allocate another DSO subband to the STA as one option. The AP always allocate the requested DSO subband as another option.

FIG. 3B represents an example protocol 302 for NPCA enabling/disabling within the wireless communications system 100. The example protocol 302 for setting up a NPCA channel switching can include: an AP's announcement/advertisement of its enabling/disabling NPCA operation by sending a Beacon or Probe Response to an associated non-AP STA, the STA notifying its the AP that the STA is capable of operating according to a NPCA protocol and requesting to enable/disable NPCA if the AP enables the NPCA operation, the AP always accepting the request from the STA by sending a NPCA response frame.

NPCA frames can include: a NPCA enable/disable request/response frame and one or more NPCA control frames.

Next, both the AP and the STA negotiate a set of NPCA operation parameters. The NPCA operation parameters can include: a mode indication, a NPCA primary channel, the set of defined channels that can be used when switching to NPCA primary channel, a switching delay when switching from primary channel to NPCA primary channel, a switching back delay when switching from NPCA primary channel to primary channel, and etc. The set of NPCA operation parameters of AP's enabling NPCA operation, AP's switching delay and AP's switching back delay are contained within the beacon or probe response frame from the AP, and the set of NPCA operation parameters of AP's disabling NPCA operation is contained within the beacon or probe response frame from the AP. The set of NPCA operation parameters of STA's enabling NPCA operation, STA's switching delay and STA's switching back delay are contained within the NPCA enable request frame from the STA, and the set of NPCA operation parameters of STA's disabling NPCA operation are contained within the NPCA disable request frame from the STA.

The switching delay defines a delay for switching from primary channel to NPCA primary channel. While, the switch back delay defines a delay for switching back from NPCA primary channel to primary channel.

When switching the NPCA primary channel in a TXOP, the dynamic channel puncture is allowed in the TXOP.

Both the DSO requests and the NPCA requests can be included in a same Action frame with the Command Type indicating whether the Action frame is for a DSO request, an NPCA request, or some other request. The DSO/NPCA request carries the indication of the DSO or NPCA. Similarly, both the DSO responses and the NPCA responses can be the same Action frame with the Command Type to indicate whether it is DSO Response, NPCA response or the other response.

Current DSO and NPCA protocols, however, have room for improving channel switching to reduce data traffic latency and increase data throughput. For example, both NPCA and DSO require STAs to switch from the primary channel to the second operating channel (i.e. DSO's DSO channels and NPCA's NPCA primary channel) and switch from secondary channel (i.e. DSO's DSO channels and NPCA's NPCA primary channel) to primary channel on a per TXOP basis, which can cause noticeable variations in data throughput for each TXOP frame exchange if the announced switch time is more than the time that the switch is needed.

The data throughput variations are in part caused by variations in transition delays (e.g. a delay to allow for channel switching between the first operating channel and the second operating channel). For example, if the second operating channel to be switched to is covered by the STA's current operating bandwidth (BW), then the transition delay is almost 0. However, when the second operating channel is not covered by the STA's current operating BW, then the STA's transition delay could be quite large. These data throughput variations are further compounded by the STA's ability to dynamically change its operating BW for each TXOP frame exchange.

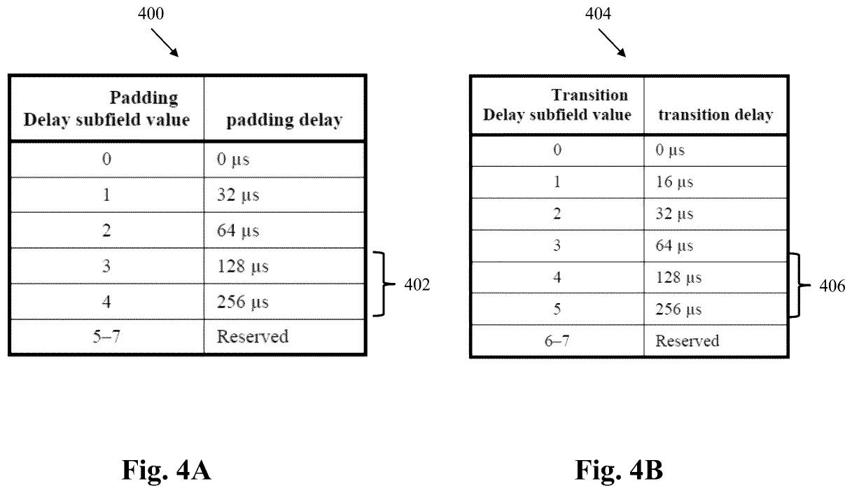

FIG. 4A represents an example padding delay 400. The padding delay 400 is contained within the beacon or probe response frame from the AP, and contained within the DSO enable/disable request frame from the STA. A set of first padding delay 400 values in micro-seconds are as shown.

If either the AP or the STA requires a padding delay (e.g. 129 μs) that is even slightly longer than one of the padding delay values (e.g. 128 μs), then the AP or the STA must select a next larger padding delay (e.g. 256 μs). This can result in a substantial padding delay increase 402 when only a small padding delay increase is actually needed, introducing unnecessary medium waste.

FIG. 4B represents an example transition delay 404. The transition delay 404 is contained within the beacon or probe response frame from the AP, and contained within the DSO enable/disable request frame from the STA. A set of first padding delay 400 values in micro-seconds are as shown.

Similar as discussed above, if either the AP or the STA requires a transition delay (e.g. 129 μs) that is even slightly longer than one of the transition delay values (e.g. 128 μs), then the AP or the STA must select a next larger transition delay (e.g. 256 μs). This can result in a substantial transition delay increase 402 when only a small transition delay increase is actually needed, also introducing unnecessary medium waste.

As discussed above the DSO protocol uses padding delay and transition delay, while the NPCA protocol uses switch delay and switch back delay.

For DSO, the padding delay defines a delay for switching to a DSO channels from the primary channel. While the transition delay defines a delay for switching back from the DSO channels to the primary channel.

For NPCA the switching delay defines a delay for switching from primary channel to NPCA primary channel. While, the switch back delay defines a delay for switching back from NPCA primary channel to primary channel.

The NPCA protocol suffers from the same delay increment concerns as discussed above for the DSO protocol.

Now discussed are improved channel switching protocols that reduce data traffic latency and increase data throughput.

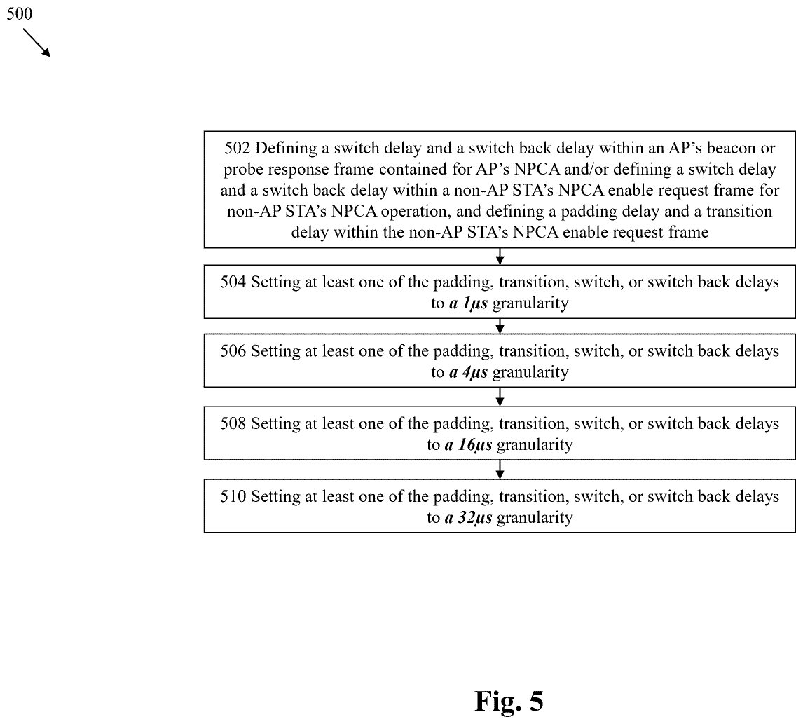

FIG. 5 represents an example set of instructions 500 for setting a channel padding, transition, switch, or switch back delay in the wireless communications system 100. The order in which the instructions are discussed does not limit the order in which other example embodiments implement the instructions unless otherwise specifically stated. In some embodiments the instructions are implemented concurrently.

In 502, defining a switch delay and a switch back delay within an AP's beacon or probe response frame contained for AP's NPCA and/or defining a switch delay and a switch back delay within a non-AP STA's NPCA enable request frame for non-AP STA's NPCA operation, and defining a padding delay and a transition delay within the non-AP STA's NPCA enable request frame.

In 504, setting at least one of the padding, transition, switch, or switch back delays to a 1 μs granularity.

In 506, setting at least one of the padding, transition, switch, or switch back delays to a 4 μs granularity.

In 508, setting at least one of the padding, transition, switch, or switch back delays to a 16 μs granularity. For example separate subfield values for the padding and/or transition delay can be defined as: 0, 16, 32, 48, 64, 80, 96, 112, 128, 144, 160, 176, 192, 208. 224, 240, 256.

In 510, setting at least one of the padding, transition, switch, or switch back delays to a 32 μs granularity. For example separate subfield values for the padding and/or transition delay can be defined as: 0, 32, 64, 96, 128, 160, 192, 224, 256.

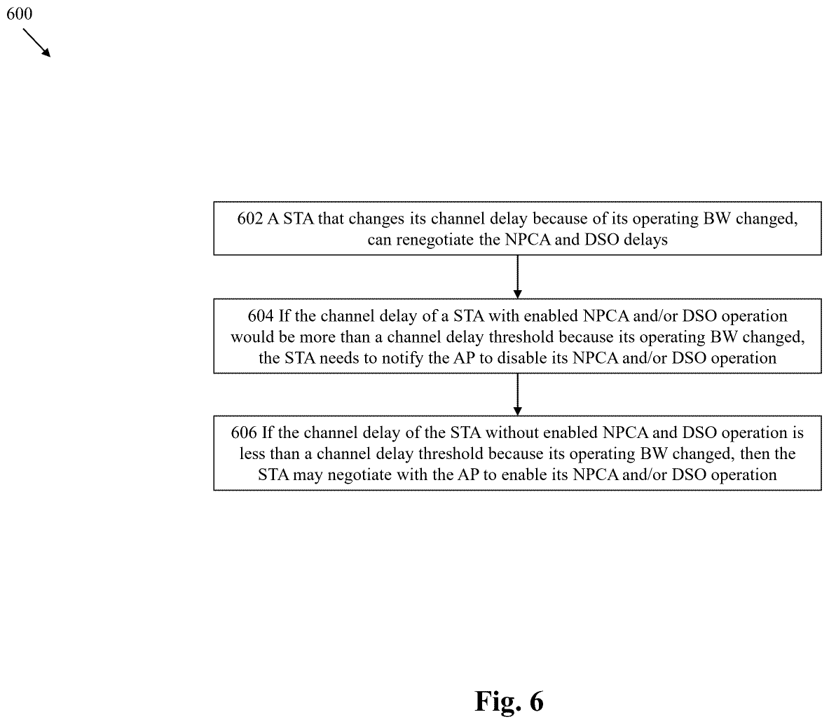

FIG. 6 represents an example set of instructions 600 for updating at least one of a channel padding, transition, switch, or switch back delay in response to a change in the STA's operating BW. Note, in the discussion that follows use of the phrase “channel delay” refers to at least one of the padding, transition, switch, or switch back delays.

In 602, under the assumption of each STA announcing its channel delays during either NPCA and/or DSO negotiations, a STA that changes its channel delay because of its operating BW changed, can renegotiate the NPCA and DSO delays.

In 604, under the assumption of AP's announcement of channel delay threshold to accept a STA's NPCA and/or DSO requests, if the channel delay of a STA with enabled NPCA and/or DSO operation would be more than a channel delay threshold because its operating BW changed, the STA needs to notify the AP to disable its NPCA and/or DSO operation.

Note, in IEEE802.11bn, the AP will not announce such threshold. However, if the STA's delay is no more than 256 μs, the NPCA, DSO can be enabled.

In 606, under the assumption of AP's announcement of channel delay threshold to accept a STA's NPCA and DSO request, if the channel delay of the STA without enabled NPCA and DSO operation is less than a channel delay threshold because its operating BW changed, then the STA may negotiate with the AP to enable its NPCA and/or DSO operation.

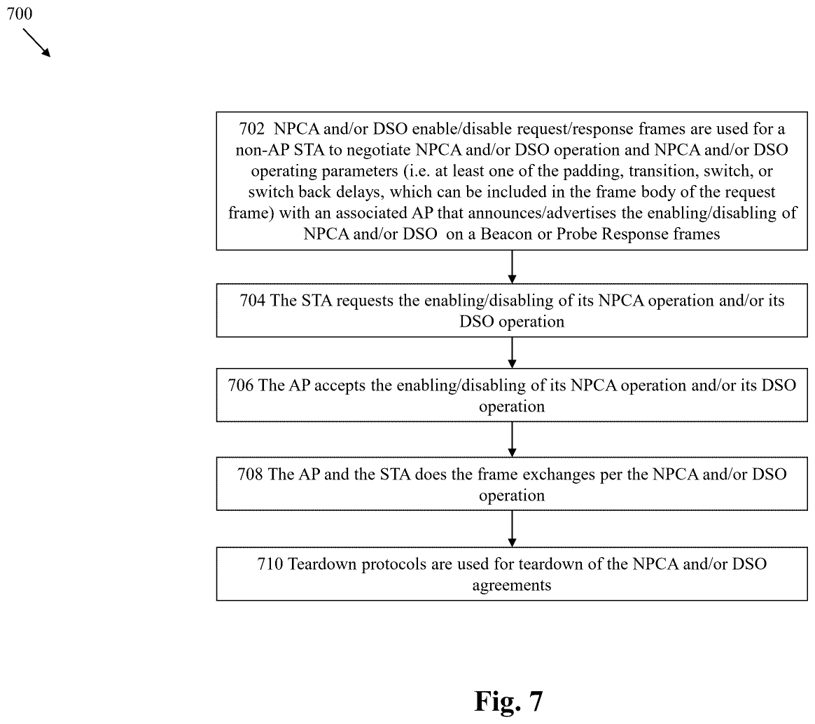

FIG. 7 represents an example set of instructions for negotiating a channel padding, transition, switch, or switch back delay in the wireless communications system.

In 702, NPCA and/or DSO enable/disable request/response frames are used for a non-AP STA to negotiate NPCA and/or DSO operation and NPCA and/or DSO operating parameters (i.e. at least one of the padding, transition, switch, or switch back delays, which can be included in the frame body of the request frame) with an associated AP that announces/advertises the enabling/disabling of NPCA and/or DSO on a Beacon or Probe Response frames.

In 704, the STA requests the enabling/disabling of its NPCA operation and/or its DSO operation.

In 706, the AP accepts the enabling/disabling of its NPCA operation and/or its DSO operation.

In 708, the AP and the STA does the frame exchanges per the NPCA and/or DSO operation.

In 710, teardown protocols are used for teardown of the NPCA and/or DSO agreements.

In many example embodiments the functionality and instructions described above is implemented using logic gates, application specific chips, firmware, and/or other hardware. However in some example embodiments this functionality and instructions can be implemented as a set of software instructions stored in a non-transitory computer-readable or computer-usable medium.

Various systems, such as controllers in APs and STAs, such as discussed in FIG. 1, can host these instructions. Such systems can include an input/output data interface, a processor, a storage device, and a non-transitory machine-readable storage medium. The machine-readable storage medium includes the instructions which control how the processor receives input data and transforms the input data into output data, using data within the storage device. The machine-readable storage medium in an alternate example embodiment is a non-transitory computer-readable storage medium. In other example embodiments the set of instructions described above can be implemented either using logic gates, application specific chips, firmware, as well as other hardware forms.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

As used herein, “predefined” is equivalent to “predetermined” and indicates a value or setting that is tuned for a particular application/embodiment/instance of the described and/or claimed subject matter.

What is claimed is:

1. A wireless communications device, comprising:
a controller is configured to switch the wireless communications device from a first operating channel to a second operating channel according to either a Non-Primary Channel Access (NPCA) channel switching protocol or a Dynamic Subchannel Operation (DSO) channel switching protocol;
wherein the wireless communications device is an access point (AP) that is configured to operate in a wireless local area network (WLAN) with at least one station (STA);
wherein the AP is configured to announce an enabling and/or disabling of the NPCA and/or the DSO protocols;
wherein the AP is configured to accept a negotiation request from the STA;
wherein the STA is configured to respectively negotiate a set of NPCA and/or DSO operating parameters in response to the AP enabling the NPCA and/or DSO protocols;
wherein the controller is configured to switch the wireless communications device from the first operating channel to the second operating channel according to the set of NPCA and/or DSO operating parameters; and
wherein the set of NPCA and/or DSO operating parameters include at least one of:
a padding delay or a switching delay which defines a delay for switching to the second operating channel from the first operating channel; and
a transition delay or a switch back delay which defines a delay for switching back to the first operating channel from the second operating channel.

2. A wireless communications device, comprising:
a controller configured to switch the wireless communications device from a first operating channel to a second operating channel according to a set of operating parameters;
wherein the set of operating parameters include at least one of:
a padding delay or a switching delay which defines a delay for switching to the second operating channel from the first operating channel;
a transition delay or a switch back delay which defines a delay for switching back to the first operating channel from the second operating channel.

3. The device of claim 2:
wherein at least one of the padding, transition, switch, or switch back delays has between a 4 μs granularity and a 32 μs granularity.

4. The device of claim 2:
wherein at least one of the padding, transition, switch, or switch back delays has a granularity of at least one of: 1 μs, 4 μs, 16 μs, and 32 μs.

5. The device of claim 2:
wherein the controller is configured to switch the wireless communications device from the first operating channel to the second operating channel according to a Non-Primary Channel Access (NPCA) channel switching protocol.

6. The device of claim 2:
wherein the controller is configured to switch the wireless communications device from the first operating channel to the second operating channel according to a Dynamic Subchannel Operation (DSO) channel switching protocol.

7. The device of claim 2:
wherein the wireless communications device is either an access point (AP) or a station (STA) that is configured to operate in a wireless local area network (WLAN).

8. The device of claim 2:
wherein the controller is configured to switch the wireless communications device from the first operating channel to the second operating channel after obtaining a TXOP.

9. The device of claim 8:
wherein the controller is configured to switch the wireless communications device from the second operating channel back to the first operating channel before releasing the TXOP.

10. The device of claim 2:
wherein the controller is configured to negotiate at least one of the padding, transition, switch, or switch back delays within either an AP's beacon or probe response frame, and/or a STA's enable/disable request frame.

11. The device of claim 2:
wherein at least one of the padding, transition, switch, or switch back delays is included in an HE control field within either an AP's beacon or probe response frame, and/or a STA's enable/disable request frame.

12. The device of claim 2:
wherein the first operating channel is an anchor channel; and
wherein the second operating channel is included in a set of non-anchor channels.

13. The device of claim 12:
wherein the wireless communications device is an access point (AP);
wherein the AP is configured to wirelessly communicate with a station (STA) as a wireless local area network (WLAN); and
wherein the controller is configured to set the anchor channel to have an operating BW equal to an operating BW of the STA.

14. The device of claim 12:
wherein the wireless communications device is an access point (AP);
wherein the AP is configured to wirelessly communicate with a station (STA) as a wireless local area network (WLAN);
wherein the controller is configured to set the anchor channel to have a fixed BW; and
wherein the STA has an operating BW that covers the fixed BW.

15. The device of claim 12:
wherein the wireless communications device is an access point (AP);
wherein the AP is configured to wirelessly communicate with a station (STA) as a wireless local area network (WLAN); and
wherein the AP is either prohibited from scheduling, or permitted to schedule, a STA for dynamic channel switching once the STA switches back to the anchor channel.

16. The device of claim 2:
wherein if at least one of the padding, transition, switch, or switch back delays is more than a predetermined threshold delay, then the controller is prevented from switching the wireless communications device from the first operating channel to the second operating channel.

17. The device of claim 2:
wherein the controller is permitted to switch the wireless communications device from the first operating channel to the second operating channel only if at least one of the padding, transition, switch, or switch back delays is less than a predetermined threshold delay.

18. A method for wireless communications channel switching, comprising:
switching the wireless communications device from a first operating channel to a second operating channel according to a set of operating parameters;
wherein the set of operating parameters include at least one of:
a padding delay or a switching delay which defines a delay for switching to the second operating channel from the first operating channel; and
a transition delay or a switch back delay which defines a delay for switching back to the first operating channel from the second operating channel.
